(19) United States
(12) Patent Application Publication
(10) Pub. No.: US 2004/0157043 A1
(43) Pub. Date: Aug. 12, 2004

(54) Process for coating apparatuses and parts thereof

(75) Inventors: Harald Keller, Ludwigshafen (DE); Ekkehard Jahns, Weinheim (DE); Christian Lach, Bad Duerkheim (DE); Stephan Huffer, Ludwigshafen (DE); Thilo Krebs, Mannheim (DE); Yi Thomann, Umkirch (DE); Thomas Frechen, Heidelberg (DE)

Correspondence Address: OBLON, SPIVAK, MCCLELLAND, MAIER & NEUSTADT, P.C., 1940 DUKE STREET, ALEXANDRIA, VA, 22314, US

(73) Assignee: BASF Aktiengesellschaft, Ludwigshafen (DE)

(21) Appl. No.: 10/364,393

(22) Filed: Feb. 12, 2003

(51) Int. Cl. B32B 31/00; B32B 1/00

(52) U.S. Cl. 428/141; 156/60

(57) ABSTRACT

A process for coating surfaces in apparatuses or apparatus parts for plant construction, preferably for chemical plant construction, involves optionally first hydrophobicizing a polymer film having a microstructure and optionally additionally macrostructured surface and then fixing it on the apparatus or apparatus part to be coated, and also apparatuses and apparatus parts thus coated.

The present invention relates to a process for coating surfaces in apparatuses or apparatus parts for plant construction, preferably for chemical plant construction. The present invention further relates to apparatuses and apparatus parts coated with a polymer film having a microstructured and optionally additionally macrostructured surface and being optionally first hydrophobicized and then fixed on the apparatus or apparatus part to be coated. By apparatuses and apparatus parts for plant construction are meant, for example, apparatus, tank and reactor walls, tanks, discharge devices, valves, pumps, filters, compressors, centrifuges, columns, heat exchangers, dryers, centrifugal separators, scrubbers, comminution machines, internals, packing elements and mixing elements, used with preference in chemical plant. The present invention further relates to apparatuses and apparatus parts coated by the process of the invention. Finally, the present invention relates to the use of the apparatuses or apparatus parts of the invention for chemical plant construction.

Settled and caked deposits in apparatuses and apparatus parts for plant construction represent a serious problem in industry, especially in the chemical industry. They particularly affect apparatus, tank and reactor walls, tank walls, discharge devices, valves, pumps, filters, compressors, centrifuges, columns, dryers, centrifugal separators, scrubbers, comminution machines, internals, packing elements and mixing elements. These deposits are also referred to as fouling.

These deposits may have a variety of damaging or hindering effects for the process and may make it necessary to shut down and clean corresponding reactors or processing machines repeatedly.

Measurement devices encrusted with deposits may lead to incorrect and misleading results, through which operating errors may occur.

A further problem which arises as a result of the formation of deposits lies in the fact that, especially in deposits in polymerization reactors, the molecular parameters such as molecular weight or degree of crosslinking differ significantly from the product specifications. If deposits become detached in the course of ongoing operation, they may contaminate the product (for example, gel specks in paints, inclusions in suspension beads). In the case of reactor walls, packing elements or mixing elements, unwanted deposits may lead, furthermore, to an unwanted change in the residence time profile of the apparatus or may impair the efficiency of the internals or mixing elements as such. Fairly coarse sections of deposits which break off may lead to blockage of discharge and processing devices, while small parts may result in impairment of the product produced.

The deposits whose formation is to be prevented are coatings which may be caused, for example, by reactions with and on surfaces. Further reasons include adhesion to surfaces, which may be caused by van der Walls forces, polarization effects or electrostatic double layers. Other important effects are stagnation of movement at the surface and possibly reactions in said stagnating layers. Finally, mention may be made of the following: precipitates from solutions, evaporation residues, cracking on locally hot surfaces, and microbiological activity.

The causes are dependent on the respective combinations of material and may act alone or in combination. While the processes resulting in the unwanted coatings have been investigated quite well (for example A. P. Watkinson and D. I. Wilson, Experimental Thermal Fluid Sci. 1997, 14, 361 and literature cited therein), the schemes for preventing the above-described deposits are lacking in uniformity. The processes known to date have technical disadvantages.

Mechanical solutions have the disadvantage that they may give rise to considerable additional costs. Additional reactor internals may, furthermore, significantly alter the flow profile of fluids in the reactors and as a result may necessitate an expensive redevelopment of the process. Chemical additives may lead to unwanted contamination of the product; some additives pollute the environment.

For these reasons, there is an increased impetus to the search for ways of directly reducing the fouling tendency by modification of apparatuses and apparatus parts for chemical plant construction.

WO 00/40775, WO 00/40774 and WO 00/40773 describe processes for coating surfaces, especially surfaces of reactors for high-pressure polymerization of 1-olefins or surfaces of heat exchangers, by electroless deposition of an NiP/polytetrafluoroethylene layer or a CuP/polytetrafluoroethylene layer by means of which the metal surfaces in question can be antiadhesively modified. When the surfaces coated by the process described are used in apparatuses and apparatus parts for chemical plant construction, especially reactors for the high-pressure polymerization of 1-olefins, however, it is observed that the surfaces are not sufficiently stable mechanically, so that following prolonged use caked deposits of product are again observed. It is, however, impossible to recoat an NiP/polytetrafluoroethylene layer which has been worn down only partially. Moreover, it is observed that an NiP/polytetrafluoroethylene layer, once deposited, is difficult to remove again if it is no longer desired in a reactor or apparatus part. Especially in reactors with rapid product change, in which occasionally reactions are to be carried out at above 400° C., a coating with NiP/polytetrafluoroethylene has been found inappropriate. A final disadvantage is that, especially when coating reactors of high volume, it is necessary to use large amounts of dipping baths, leading to considerable solvent wastes.

WO 96/04123 discloses self-cleaning surfaces which may be coated with polytetrafluoroethylene and have particularly hydrophobic properties. The structuring is brought about by incipient etching or embossing of the surface, by physical methods such as sandblasting or ionic etching using, for example, oxygen. Subsequently, the surface is coated with Teflon. The mechanical stability of coats hydrophobicized in this way, however, is much too low for use in chemical apparatus construction, especially for polymerization reactors, where strong shear forces act.

Furthermore, structured surfaces having hydrophobic properties are known (EP-A 0 933 388) which are prepared by, for example, incipiently etching the surface in question, thus producing elevations or grooves on the surface and subsequently covering them with a coat of a hydrophobic polymer, polyvinylidene fluoride for example. These coats may further comprise fluorinated waxes, examples being Hostaflons®. The surfaces modified in this way are hydrophobic and oleophobic. Applications cited include wafer mounts in semiconductor production, and also the preparation or coating of headlamps, windscreens or solar cell covers. A disadvantage of the process, however, is that, following partial mechanical breakdown, the structuring is difficult to renew.

Finally, Tsujii et al. in Angew. Chem. 1997, 109, 1042 have published a process for rendering a microstructured metal surface (in, for example, aluminum which has been anodically oxidized) repellent to numerous liquids by means of subsequent hydrophobicization. Again, this process provides structuring which is difficult to renew. Moreover, the surfaces prepared by the authors are still far removed from surfaces exhibiting ideal oil repulsion (p. 1044, middle).

It is an object of the present invention

to provide apparatuses and parts thereof with structured surfaces which have antiadhesive properties and which are easy not only to apply but also to remove again;

to provide a process for producing such apparatuses or parts thereof with structured surfaces.

We have found that this object is achieved by preparing a polymer film comprising a microstructured surface which may optionally have been macrostructured, first hydrophobicizing said film and then fixing it on the apparatus or apparatus part to be coated. The surfaces treated in accordance with the invention are hydrophobic and oleophobic and prevent settled and caked deposits.

The process of the invention comprises a number of steps.

In the first, optional step, a surface to be protected against settled and caked deposits is cleaned.

In the second step, a film is prepared from an appropriate material. Appropriate materials are polymers such as, for example, polycarbonates, especially Makrolon®, polystyrenes, styrene copolymers such as, for example, Terluran®, polyethylenes and ethylene copolymers, polypropylenes, polyethylene terephthalates (PET), polybutylene terephthalates, polyvinyl chlorides and polyamides. This film is subsequently microstructured using known methods. The microstructuring may be carried out, for example, by incipient etching or embossing of the surface, by physical methods such as blasting with an appropriate material, such as sand, or by incorporation of small, dust-sized particles. Moreover, chemical methods such as ionic etching with oxygen, for example, are suitable structuring processes. A preferred method is described in EP-A 0 933 388, page 4, column 5, lines 39-50 and in R. Wechsung, Mikroelektronik 1995, 9, 34. The microstructuring of the surface comprises elevations with an average height of from 50 nm to 10 μm and a spacing of from 50 nm to 10 μm. Optionally, the film may comprise a superstructure or macrostructure with elevations in an average height of from 10 μm to 1 mm and an average spacing of from 10 μm to 1 mm. Polymer films having an additional macrostructure are notable for the fact that they are able to withstand greater mechanical stress, and they are much less sensitive to pressure, in particular, than those polymer films which merely have microstructuring.

Next, the surface is optionally hydrophobicized. A variety of reagents may be used for hydrophobicizing.

Suitable hydrophobicizers are, generally, substances possessing long linear or branched alkyl chains, long fluorinated alkyl chains or dimethylsiloxane chains. Particularly suitable terminal groups of these chains are the methyl, trifluoromethyl and trimethylsilyl groups.

Examples of particularly suitable hydrophobicizers are:

polychlorotrifluoroethylene,

polytetrafluoroethylene,

poly-n-butyl methacrylate,

poly-tert-butyl methacrylate,

polyhexyl methacrylate,

poly-2-ethylhexyl methacrylate,

polybutyl acrylate,

poly-2-ethylhexyl acrylate,

poly dimethylsiloxane,

polyisobutene,

long-chain polyalkyl vinyl ethers having 8 to 36 carbon atoms in the alkyl chain;

polyesters constructed from aliphatic or phenolic dialcohols having 2 to 18 carbon atoms on the one hand, e.g., 1,2-propanediol, 1,3-propanediol, 1,4-butanediol, 1,6-hexanediol or bisphenol A, and dicarboxylic acids having 3 to 18 carbon atoms on the other hand, such as adipic acid or decanedicarboxylic acid, for example. Suitable polyesters are optionally terminated with long-chain monoalcohols having 4 to 24 carbon atoms such as 2-ethylhexanol or octadecanol. Furthermore, the polyesters may be terminated with long-chain monocarboxylic acids having 4 to 24 carbon atoms, such as stearic acid, for example.

Polyesters constructed from terephthalic acid and aliphatic dialcohols having 2 to 18 carbon atoms, e.g., 1,2-propanediol, 1,3-propanediol, 1,4-butanediol, 1,6-hexanediol, and dicarboxylic acids having 3 to 18 carbon atoms, such as adipic acid and decanedicarboxylic acid, for example. Suitable polyesters are optionally terminated with long-chain monoalcohols having 4 to 24 carbon atoms, such as 2-ethylhexanol or octadecanol.

Waxes such as, for example, polyethylene waxes, polypropylene waxes, montanic acid waxes, montan ester waxes, amide waxes such as distearoylethylenediamine, for example, Fischer-Tropsch waxes, polytetrafluoroethylene waxes, beeswax, carnauba wax, wool wax, candelilla wax, etc.

fatty acids having more than 8 carbon atoms,

fatty alcohols having more than 8 carbon atoms,

esters of fatty acids having more than 8 carbon atoms with monofunctional alcohols,

esters of fatty acids having more than 8 carbon atoms with polyfunctional alcohols such as, for example, glycerol, ethylene glycol, propylene glycol, sorbitol, glucose, sucrose and trimethylolpropane;

amides of fatty acids having more than 8 carbon atoms with monofunctional amines,

amides of fatty acids having more than 8 carbon atoms with polyfunctional amines such as, for example, ethylenediamine, diethylenetriamine, triethylenetetramine, polyethyleneimine and polyvinylamine.

Copolymers containing structural elements of the formulae A to D:

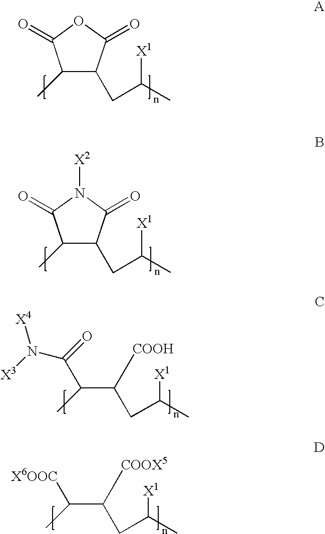

where

n is an integer from 3 to 5 000

X¹-X⁶ are hydrogen,

C₁-C₃₆ alkyl, such as methyl, ethyl, n-propyl, isopropyl, n-butyl, isobutyl, sec-butyl, tert-butyl, n-pentyl, isopentyl, sec-pentyl, neopentyl, 1,2-dimethylpropyl, isoamyl, n-hexyl, isohexyl, sec-hexyl, n-heptyl, isoheptyl, n-octyl, n-nonyl, n-decyl, n-dodecyl, n-hexadecyl, n-octadecyl, n-eicosyl, n-C₃₀H₆₁ or n-C₃₆H₇₃;

C₁-C₃₆ alkoxy groups, preferably C₁-C₆ alkoxy groups such as methoxy, ethoxy, n-propoxy, isopropoxy, n-butoxy, isobutoxy, sec-butoxy, tert-butoxy, n-pentoxy, isopentoxy, n-hexoxy, isohexoxy, n-octoxy, n-decoxy, O-n-C₂₀H₄₁, O-n-C₃₀H₆₁ or O-n-C₃₆H₃₇;

—O—C(═O)—C₁-C₃₆ alkyl, where C₁-C₃₆ alkyl is as defined above,

—(CH₂)ₐ—(CF₂)_{b}—CF₃, —O—(CH₂)ₐ—(CF₂)_{b}—CF₃ or —O—C(═O)—(CH₂)ₐ—(CF₂)_{b}—CF₃, where a is an integer from 0 to 6 and b is an integer from 1 to 16;

—(CH₂)ₐ—(O)_{c}—(Si(CH₃)₂O)_{d}—R where a is an integer from 0 to 6, c is 0 or 1, d is an integer from 2 to 10 000 and R is H, Si(CH₃)₃, C₁-C₃₆ alkyl or O— C₁-C₃₆ alkyl and C₁-C₃₆ alkyl is as defined above;

Further compounds suitable for hydrophobicizing are silanes of the formula R¹R²R³SiR⁴, where:

R¹ to R³ independently of one another are —H, —Cl, —OCH₃, —OC₂H₅, —OC₃H₇, —OC₄H₉;

R⁴ is

C₁-C₃₆ alkyl, such as methyl, ethyl, n-propyl, isopropyl, n-butyl, isobutyl, sec-butyl, tert-butyl, n-pentyl, isopentyl, sec-pentyl, neopentyl, 1,2-dimethylpropyl, isoamyl, n-hexyl, isohexyl, sec-hexyl, n-heptyl, isoheptyl, n-octyl, n-nonyl, n-decyl, n-dodecyl, n-hexadecyl, n-octadecyl, n-eicosyl, n-C₃₀H₆₁ or n-C₃₆H₇₃;

—(CH₂)ₐ—(CF₂)_{b}—CF₃ or —O—(CH₂)ₐ—(CF₂)_{b}—CF₃, where a is an integer from 0 to 6 and b is an integer from 1 to 16;

—OSi(CH₃)_{3.}

Further compounds suitable for hydrophobicizing are silicone oils with or without Si—H groups and also silicone surfactants containing (H₃C)₃SiO—Si(CH₃)—OSi(CH₃)₃ groups, available commercially, for example, from Wacker GmbH.

The hydrophobicizers are dissolved in an appropriate solvent and then applied to the film, for example, by spraying, roll application or dipping of the film. Thereafter, the films are dried, optionally at elevated temperature (40-70° C.). Examples of appropriate solvents are acetone, ethanol, isopropanol, THF, petroleum spirit, toluene, and xylene.

Suitable concentrations of the hydrophobicizers are from 0.01 to 5% by weight, preferably from 0.1 to 2% by weight, and with particular preference from 0.3 to 1% by weight.

The film hydrophobicized and structured as described above is fixed to the surface to be protected against settled and caked deposits. Fixing may be done, for example, by adhesive bonding and laminating processes. In principle, all common adhesives are suitable for adhesive bonding processes, such as solvent-based adhesives, water-based adhesives, hot-melt adhesives, heat-curable adhesives and UV-curable adhesives. For instance, the surface to be protected may be sprayed with a spray adhesive, an example being Spray Mount® from Minnesota Mining and Manufacturing (3M), and then the film may be applied. Alternatively, the structured films may be provided with a self-adhesive layer and an easily removable protective film. The protective film is then removed simply by peeling and the film is adhered directly onto the surface to be protected.

One particular embodiment of the present invention comprises a process for producing planar apparatus parts to be protected against settled and caked deposits, examples being planar metal sheets. Planar metal sheets are advantageously laminated with the structured film, by pressing the film onto the sheet using a roller and so fixing it.

The apparatus parts coated in accordance with the process of the invention may be used in numerous different kinds of apparatus for plant construction, chemical plant construction being preferred.

The apparatuses comprise liquid, gas/liquid, liquid/liquid, solid/liquid, gas/solid or gas reactors present, for example, in the following embodiments: stirred-tank, jet loop and jet reactors, jet pumps, residence-time cells, static mixers, stirred columns, tubular reactors, cylindrical stirrers, bubble columns, jet and venturi scrubbers, fixed-bed reactors, reaction columns, evaporators, rotating-disk reactors, extraction columns, compounding and mixing reactors and extruders, mills, belt reactors or rotary tubes;

discharge devices comprise, for example, discharge ports, discharge funnels, discharge pipes, valves, discharge stopcocks or ejection devices.

Valves comprise, for example, stopcocks, slide valves, bursting disks, nonreturn valves or disks.

Pumps comprise, for example, centrifugal pumps, gear pumps, screw displacement pumps, eccentric screw pumps, annular rotating piston pumps, reciprocating piston pumps, diaphragm pumps, screw trough pumps or liquid jet pumps, and also reciprocating piston vacuum pumps, reciprocating piston membrane vacuum pumps, rotating piston vacuum pumps, rotating plunger vacuum pumps, liquid-ring vacuum pumps, roller piston vacuum pumps or fluid entrainment pumps, and also parts of said pumps.

Filter apparatuses comprise, for example, fluid filters, fixed-bed filters, gas filters, sieves or separators.

Compressors comprise, for example, piston compressors, piston diaphragm compressors, positive displacement rotary compressors, rotary piston compressors, rotary multivane compressors, liquid-ring compressors, rotary compressors, Roots compressors, screw compressors, jet compressors or turbo compressors.

Centrifuges comprise, for example, screen-type centrifuges or solid-wall centrifuges, preference being given to disk centrifuges, solid-wall screw centrifuges (decanters), screen conveyor centrifuges and reciprocating pressure centrifuges.

Centrifugal separators comprise, for example, cyclones, multicyclones, centrifugal drop separators or rotary flow dust collectors.

Scrubbers comprise scrubbing towers, jet scrubbers, cyclone scrubbers, rotary scrubbers or venturi scrubbers.

Columns comprise containers with exchange trays, preference being given to bubble-cap, valve or sieve trays. In addition, the columns may be filled with different packing elements, such as saddles, Raschig rings or beads, which may likewise be protected against contamination using polymer films in accordance with the invention.

Internals in reactors and containers comprise, for example, thermocouple sleeves, flow disruptors, foam breakers, packing elements, spacers, centering devices, flange connections, static mixers, analytical instruments such as pH or IR probes, conductivity measuring instruments, level measuring instruments or foam probes.

Extruder elements comprise, for example, screw shafts and screw elements, extruder valves, plastification screws or injection nozzles.

The apparatus, container and reactor walls may comprise a variety of materials, preference being given to metallic materials. Particularly preferred materials are steels.

The abovementioned apparatuses are used preferably in chemical plants but also in the food industry. Examples that may be mentioned include milk processing in dairies and the brewing of beer.

The surfaces in the abovementioned apparatuses or apparatus parts, when said surfaces have been treated by films adhered to them or applied by lamination, are extremely difficult for liquids to wet, irrespective of whether the liquids are hydrophobic, oleophobic, or dispersions of hydrophobic and oleophobic liquids in the presence of one or more emulsifiers. Neither hydrophobic nor oleophobic liquids leave residues on the surfaces treated in accordance with the invention.

The present invention additionally provides apparatuses or apparatus parts for chemical plant construction, comprising one or more difficult-to-wet surfaces of the invention. No caked or settled deposits are observed on these walls, even in the course of prolonged use, and irrespective of whether the process in the reactor is carried out in an aqueous medium, in lipophilic solvents, or in emulsions using emulsifiers. The apparatuses and apparatus parts coated in accordance with the invention have excellent self-cleaning properties, as described, for example, in R. Fürstner et al., Chem. Ing. Tech. 2000, 72, 972. The mechanical stability of the surfaces treated in accordance with the invention is good, and their service life is long. Finally, it has been found that, even after prolonged use, the polymer films fixed in accordance with the invention, applied for example by adhesion or lamination, can be removed easily when required. This is the case in particular when the polymer film has been fixed only to certain important points on the apparatus wall.

### Working Examples

### EXAMPLE 1

A negative mold was produced by UV lithography of a photosensitive polymer (Ozatec NL 133 from Morton Electronic Materials GmbH) and subsequent electroforming with nickel. Using this negative mold, a polycarbonate film was cast. This film had a microstructure with elevations about 2 μm wide (measured at half-height) and 4 μm high in a spacing of 6 μm. The resulting film was hydrophobicized using Dynasylan F (Degussa-Hüls AG), by dissolving the Dynasylan F at a concentration of 0.1 percent by weight in isopropanol and spraying the solution onto the film with the aid of an air brush. A stainless steel plate was then sprayed with an aqueous solution of the adhesive Acronal V 210 (BASF AG). After the layer of adhesive had dried, the film was laminated onto the adhesive-coated side of the stainless steel plate using a rubber roller. The film-coated stainless steel plate was mounted on a planar table with an angle of inclination of 20°. Then the following liquids were applied dropwise using a pipette:

water with a drop mass of 46 mg

coffee with a drop mass of 54 mg

liquid honey available commercially from Langnese, with a drop mass of 80 mg

aqueous hydrochloric acid (32% by weight) with a drop mass of 44 mg

aqueous sodium hydroxide solution (5% by weight) with a drop mass of 52 mg

aqueous solution of a vinylpyrrolidone-vinylimidazole copolymer (30% by weight) with a drop mass of 40 mg

aqueous polymer dispersion Acronal® 290 D (BASF AG) with a drop mass of 58 mg

aqueous polymer dispersion Styronal® D 808 (BASF AG) with a drop mass of 54 mg

aqueous polymer dispersion Acronal® V210 (BASF AG) with a drop mass of 43 mg

None of the liquids caused wetting of the coated stainless steel plate. In all of the experiments, the drops ran in the form of beads from the coated stainless steel plate without leaving any residues.

### Comprative Example 1

In a comparative experiment, a smooth (unstructured) and unhydrophobicized polycarbonate film was laminated onto a stainless steel plate. Under the same conditions (same drop mass, 20° inclination angle) the same test liquids as in Example 1 were applied dropwise. In all of the experiments the surface was wetted, and all liquids, with the exception of water, left residues on the coated stainless steel plate.

### EXAMPLE 2

A structured but not additionally hydrophobicized polypropylene film (Huhtamaki Van Leer Packaging (Deutschland) GmbH & Co. KG, 4P Folie Forchheim) was laminated onto a stainless steel plate as described in Example 1. The film-coated stainless steel plate was mounted on a planar table with an angle of inclination of 20°. Then the following liquids were applied dropwise using a pipette:

water with a drop mass of 46 mg

coffee with a drop mass of 54 mg

honey available commercially from Langnese, with a drop mass of 80 mg

aqueous hydrochloric acid (32% by weight) with a drop mass of 44 mg

aqueous sodium hydroxide solution (5% by weight) with a drop mass of 52 mg

aqueous solution of a vinylpyrrolidone-vinylimidazole copolymer (30% by weight) with a drop mass of 40 mg

aqueous polymer dispersion Acronal® 290 D (BASF AG) with a drop mass of 58 mg

aqueous polymer dispersion Styronal® D 808 (BASF AG) with a drop mass of 54 mg

aqueous polymer dispersion Acronal® V210 (BASF AG) with a drop mass of 43 mg

None of the liquids caused wetting of the coated stainless steel plate. In all of the experiments, the drops ran in the form of beads from the coated stainless steel plate without leaving any residues.

### Comparative Example 2

In a comparative experiment, a smooth (unstructured) and unhydrophobicized polypropylene film was laminated onto a stainless steel plate. Under the same conditions (same drop mass, 20° inclination angle) the same test liquids as in Example 2 were applied dropwise. In all of the experiments the surface was wetted, and all liquids, with the exception of water, left residues on the coated stainless steel plate.

### EXAMPLE 3

The microstructured polycarbonate film from Example 1 was laminated onto a stainless steel plate. The film-coated stainless steel plate was mounted on a planar table with an angle of inclination of 20°. Subsequently 100 mg/m² of fine carbon black (Printex V from Degussa-Hüls AG, average diameter of the primary particles: 25 nm) were spread over the plate laminated with the microstructured film. The plate was then briefly rinsed with water. Within a few seconds, carbon black was no longer visually detectable on the surface.

### Comparative Example 3

The unstructured polycarbonate film from Comparative Example 1 was laminated onto a stainless steel plate. The film-coated stainless steel plate was mounted on a planar table with an angle of inclination of 20°. Subsequently 100 mg/m² of fine carbon black (Printex V from Degussa-Hüls AG, average diameter of the primary particles: 25 nm) were spread over the plate laminated with the film. The plate was then briefly rinsed with water. Even after 5 minutes, carbon black was still visually perceptible on the film.

We claim:

1. A process for coating surfaces in apparatuses or apparatus parts for plant construction, which comprises optionally first hydrophobicizing a polymer film having a microstructured and optionally additionally macrostructured surface and then fixing it on the apparatus or apparatus part to be coated.

2. A process for coating surfaces as claimed in claim 1, wherein a polymer film is used which has a microstructure comprising elevations with an average height of from 50 nm to 10 μm and a spacing of from 50 nm to 10 μm and optionally a macrostructure with elevations in an average height of from 10 μm to 1 mm and an average spacing of from 10 μm to 1 mm.

3. A process for coating surfaces as claimed in claim 1, wherein the structured polymer film is adhered to the apparatus or apparatus part to be coated.

4. A process for coating surfaces as claimed in claim 2, wherein the structured polymer film is adhered to the apparatus or apparatus part to be coated.

5. A process for coating surfaces as claimed in claim 1, wherein the structured polymer film is laminated to the apparatus or apparatus part to be coated.

6. A process for coating surfaces as claimed in claim 2, wherein the structured polymer film is laminated to the apparatus or apparatus part to be coated.

7. An apparatus or apparatus part for plant construction having an optionally hydrophobicized polymer film with microstructured and optionally additionally macrostructured surface fixed to its surfaces to be protected against contamination.

8. An apparatus or apparatus part as claimed in claim 7, wherein the polymer film comprises elevations with an average height of from 50 nm to 10 μm and a spacing of from 50 nm to 10 μm and optionally a macrostructure with elevations in an average height of from 10 μm to 1 mm and an average spacing of from 10 μm to 1 mm.

9. Chemical plant construction comprising apparatus or apparatus parts as claimed in claim 7.

10. Chemical plant construction comprising apparatus or apparatus parts as claimed in claim 8.
